(19) United States
(12) Patent Application Publication
(10) Pub. No.: US 2012/0140799 A1
(43) Pub. Date: Jun. 7, 2012

(54) METHOD AND APPARATUS FOR DETECTING ORTHOGONAL FREQUENCY DIVISION MULTIPLEXING SIGNAL

(75) Inventors: Sun Min LIM, Daejeon-si (KR); Hoi Yoon Jung, Daejeon-si (KR); Sang Won Kim, Daejeon-si (KR); Byung Jang Jeong, Daejeon-si (KR)

(73) Assignee: ELECTRONICS AND TELECOMMUNICATIONS RESEARCH INSTITUTE, Daejeon-si (KR)

(21) Appl. No.: 13/302,473

(22) Filed: Nov. 22, 2011

(30) Foreign Application Priority Data
Nov. 25, 2010 (KR) 10-2010-0118277

(51) Int. Cl. H04B 1/38; H04B 17/00; H04B 1/06

(52) U.S. Cl. 375/219; 375/340; 375/224

(57) ABSTRACT

Disclosed is a method for detecting single channel orthogonal frequency division multiplexing (OFDM) and channel bonded signals through a single channel receiver, the method including: receiving sensing data through a single channel receiving radio frequency chain; obtaining a cyclostationary feature of the sensing data; and determining presence of a signal on the basis of the cyclostationary feature of the sensing data. If it is determine that the signal exists, the kind of signal is determined by comparing the cyclostationary feature of the sensing data with a cyclostationary feature of a known OFDM signal. If it is determine that the signal exists, whether channels of the signal are bonded is determined by comparing the cyclostationary feature of the sensing data with a cyclostationary feature of a known OFDM signal.

### CROSS-REFERENCE TO RELATED APPLICATIONS

This application claims the benefit of priority of Korean Patent Application No. 10-2010-0118277 filed on Nov. 25, 2010, all of which are incorporated by reference in their entirety herein.

### BACKGROUND OF THE INVENTION

1. Field of the Invention

The present invention provides wireless communications, and more particularly, to a method for detecting an orthogonal frequency division multiplexing (OFDM) signal.

2. Related Art

With rapid development of a wireless communication system and development of various wireless communication services, a strict frequency band has been required to solve problem of coexistence with the existing communication systems. However, almost all current commercially-available frequency bands have been allocated and thus there is great scarcity of frequency resources for a new wireless platform. The current state of frequency use shows that there is little room for using a frequency band less than several GHz, i.e., a low frequency band. To solve such a problem of frequency lack, there has recently been proposed a cognitive radio (CR) technology in which an unoccupied frequency band allocated but not being actually used is detected and employed by efficient sharing.

The existing wireless communication system has strictly controlled the frequency resources under the national frequency policy. Thus, operators have obtained approval from government and used an allocated frequency resource. However, the CR technology supports a communication system as opposed to the existing wireless communication system, where the frequency resource allocated but not being used can be employed without interfering with wireless communications of the existing operators.

Responding to a recent tendency that demand for the scarce frequency resources suddenly increases, necessity of the CR technology has been on the rise, and a lot of interest and researches in the CR technology have been made since Notice of Proposed Rule Making (NPRM) of Federal Communication Commission (FCC) of the United States mentioned possibility in December 2003. As a representative example, Institute of Electrical and Electronic Engineers (IEEE) 802.22 Wireless Regional Area Networks (WRAN) has been standardized for the purpose of developing a communication platform using the CR technology. IEEE 802.22 WRAN will be used for the outskirts of a city in the United States or Canada or for a developing country, and aims for providing a wireless communication service to a television (TV) band being not in use through an intelligent wireless communication technology.

As above, the standardization and development for the CR technology have been currently activated, but there are lots of problems that have to be solved and most of configuration technology has not been decided yet because it is still in an early stage.

As technology for management, distribution and interference-detection of a wireless channel with respect to multi-channels, the CR technology is likely to be complementarily employed as interlocking with the next-generation wireless communication in the future. For example, in a shadow region of a cellular environment or a countryside or the like where the size of a cell has to be increased, the CR technology may become a good alternative technology for effectively transmitting data at high speed without frequency interference.

Meanwhile, a CR system such as IEEE 802.22, European Computer Manufacturers Association (ECMA) 392 and IEEE 802.11af, the standardization of which is going on, employs an orthogonal frequency division multiplexing (OFDM)method, and supports a channel bonding for enhancing a data transmission rate. In a conventional IEEE 802.11 OFDM system, a single channel system transmits additional information for notifying whether channels are bonded or not.

The method of transmitting the additional information lowers the data to transmission rate, and determination or the like about whether the channels are bonded decreases an initial access speed of a communication module to a network. To solve such a problem, there is a need for weighing a method for detecting an OFDM signal to grasp detection of a signal, the kind of signal and whether the channels are bonded, by a signal processing algorithm without the additional information.

### SUMMARY OF THE INVENTION

The present invention provides a method for detecting an orthogonal frequency division multiplexing (OFDM) signal in a wireless communication system, and an apparatus supporting the same.

In an aspect, a method for detecting an orthogonal frequency division multiplexing (OFDM) signal using a single channel receiver includes: receiving sensing data through a single channel receiving radio frequency chain; obtaining a cyclostationary feature of the sensing data; and determining presence of a signal on the basis of the cyclostationary feature of the sensing data.

The determining the presence of the signal may include comparing the cyclostationary feature of the sensing data with a cyclostationary feature of a known OFDM signal obtained from parameters of the known OFDM signal.

If the signal exists as a result of determining the presence of the signal, the kind of signal may be determined by comparing the cyclostationary feature of the sensing data with a cyclostationary feature of a known OFDM signal.

If the signal exists as a result of determining the presence of the signal, the number of bonded channels of the signal may be determined by comparing the cyclostationary feature of the sensing data with a cyclostationary feature of a known OFDM signal.

The method may further include estimating a spectrum based on the sensing data; and determining whether channels receiving the signal are bonded on the basis of the estimated spectrum.

The determining whether the channels receiving the signal are bonded on the basis of the estimated spectrum may include comparing a feature of a guard band shown in the estimated spectrum with a guard band of a known OFDM signal.

In another aspect, a wireless apparatus for detecting an orthogonal frequency division multiplexing (OFDM) signal using a single channel receiver includes: a single channel sensing receiving radio frequency (RF) unit which receives a wireless signal and senses an interest frequency band; an analog/digital (A/D) converter which converts the wireless signal into a digital signal; a cyclostationary feature operation unit which obtains a cyclostationary feature of the digital signal; a signal detection and kind determination unit which determines the kind of wireless signal on the basis of the cyclostationary feature of the digital signal; and a channel bonding determination unit which determines whether channels are bonded on the basis of the kind of wireless signal determined in the signal detection and kind determination unit.

The wireless apparatus may further include a spectrum estimation unit which estimates a spectrum based on the digital signal; and a guard band estimation unit which estimates a bandwidth of a guard band on the basis of the estimated spectrum.

In still another aspect, a wireless apparatus includes a transceiver which receives a wireless signal; and a processor which functionally connects with the transceiver and performs signal detection, the transceiver receiving sensing data through a signal channel receiving radio frequency (RF) chain, the processor obtaining a cyclostationary feature of the sensing data, and the cyclostationary feature of the sensing data being used for determining presence of a signal.

The processor may determine the presence of the signal by comparing the cyclostationary feature of the sensing data with a cyclostationary feature of a known OFDM signal obtained from parameters of the known OFDM signal.

If the signal exists with a result that the processor determines the presence of the signal, the kind of signal may be determined by comparing the cyclostationary feature of the sensing data with a cyclostationary feature of a known OFDM signal.

If the signal exists with a result that the processor determines the presence of the signal, whether channels of the signal are bonded may be determined by comparing the cyclostationary feature of the sensing data with a cyclostationary feature of a known OFDM signal.

The processor may estimate a spectrum based on the sensing data, and determine whether channels receiving the signal are bonded on the basis of the estimated spectrum.

The processor may determine whether the channels receiving the signal are bonded on the basis of the estimated spectrum by comparing a feature of a guard band periodically shown in the estimated spectrum with a guard band of a known OFDM signal.

Accordingly, the data transmission rate can be improved because there is no need for transmitting the additional information, and the communication module's initial access to a network can be quickly performed since the channel bonding information is obtained from the sensing module.

### BRIEF DESCRIPTION OF THE DRAWINGS

FIG. 1 shows an example of a process for detecting a signal through a cyclostationary feature in a cognitive radio (CR) system.

FIG. 2 schematically illustrates an environment of the CR system to which the present invention can be applied.

FIG. 3 illustrates blocks of stages for detecting an OFDM in a wireless apparatus in which the present invention can be embodied.

FIG. 4 is a block diagram illustrating the wireless apparatus in which an exemplary embodiment of the present invention is embodied.

### DESCRIPTION OF EXEMPLARY EMBODIMENTS

Below, an exemplary embodiment of the present invention will be described in detail with reference to accompanying drawings.

Hereinafter, sensing refers to detecting a signal in an interest frequency band in order to know which frequency band is occupied by a signal of another user, in other words, whether there exists another user operating in the interest frequency band.

The sensing may be performed by a terminal, and the terminal may also be called user equipment (UE), a mobile station (MS), a mobile terminal (MT), a portable device, an interface card, etc. The terminal is a wireless apparatus capable of wireless communication using the interest frequency band in accordance with a method defined by various standards related to the wireless communication. A protocol and a channel accessing method to be used by the wireless apparatus for the wireless communication are beyond the scope of the present invention, and the technical idea of the present invention is not limited by the channel accessing method, the protocol and a frame structure for wireless communication, modulation, a coding method, etc. in the wireless apparatus. For example, the terminal may be a discretionary functional medium having medium access control (MAC) and wireless-medium physical layer (PHY) interfaces satisfying IEEE 802.11 af, IEEE 802.22 or ECMA 392 standards.

Also, there may be various kinds of signal to become a target of sensing in the interest frequency band. The signal to be sensed may be a signal transmitted by a wireless apparatus of another wireless communication system operating in the interest frequency band, or a signal transmitted by a terminal of the same type of wireless communication system as a sensing terminal. The technical scope of the present invention is not limited by whether a signal to be detected by the sensing terminal is transmitted by which wireless apparatus. A signal to be detected may be a signal transmitted through a bonded channel as a signal transmitted by an orthogonal frequency division multiplexing (OFDM) method.

As necessary, a certain frequency band can be allowed for only a wireless apparatus licensed to use the corresponding frequency band. In such a frequency band, a user or a wireless apparatus having the authority to use the corresponding frequency band may be variously called an incumbent user, a primary user, a licensed device, etc. Hereinafter, it will be commonly called a first user.

To use such a limited frequency band efficiently, even though a specific frequency band is opened to only specific first users, if the specific frequency band is not being used by the first users, the corresponding frequency band may be opened to other wireless apparatus/wireless communication systems. To make an unlicensed user use the corresponding frequency band, it is previously sensed whether the first user occupies the corresponding frequency band. Also, in the case that the unlicensed user is using the corresponding frequency band as a signal of the first user is not detected in the corresponding frequency band, there is a need for periodically sensing whether the signal of the first user is detected in the corresponding frequency band since the first user may want to use again the frequency band being occupied by the unlicensed user. Furthermore, when other unlicensed user uses the frequency band, the signal of other unlicensed user is affected as interference. Thus sensing the signal of the first user and/or other unlicensed user is necessary for protection of the first user and that coexistence with other unlicensed users.

If the signal of the first user is detected in the corresponding frequency band during the previous sense before using the corresponding frequency band, another frequency band has to be used. Also, even though the unlicensed user starts to use the corresponding frequency band as the signal of the first user is not detected in the corresponding frequency band, the unlicensed user has to stop using the corresponding frequency band if the signal of the first user is detected as a result of sensing.

The signal detection technology is a core technology for sharing the frequency resources, which is for sensing a current state of frequency use by detecting a frequency spectral environment, and preventing interference with the first user and/or other unlicensed users using the interest frequency band. A spectral sensing technology may be classified into a transmitter detecting method, a receiver detecting method, and an interference detecting method. In the transmitter detecting method as the most used sensing method in general, the unlicensed user who wants to use the interest frequency band independently detects a signal transmitted from the first user and/or other unlicensed users through regional observation. The transmitter detecting method includes a matched filter detecting method, an energy detecting method, a cyclostationary detecting method, and so on.

The cyclostationary detecting method employs a distinctive feature (e.g. periodical character) of a signal transmitted from each first user and/or other unlicensed users for signal detection in the interest frequency band. Generally, a signal modulated by modulation scheme used in wireless communication includes a component having an intrinsic cycle. For example, a single carrier system includes a sine wave component having an intrinsic cycle, a ultra wideband (UWB) system includes a pulse train component having an intrinsic cycle, a band spreading system includes a spreading code or hopping sequence component having an intrinsic cycle, and an OFDM system includes a cyclic prefix (CP) component having an intrinsic cycle. The CP may be differently called a guard interval (GI) or the like in accordance with systems.

Typically, such cyclic components are intentionally employed by a receiver to estimate a parameter such as a carrier phase, pulse timing, multi-path arrival, etc. Thus, even though transmission data has a characteristic of stationary random process, the modulated signal shows a cyclostationary feature because its average, autocorrelation function or the like statistically have a cycle.

In general, the autocorrelation function and a power spectral density function are used for signal analysis of the stationary random process, but such a cyclostationary signal may employ a spectral correlation function since its cyclic feature makes correlation between frequency components.

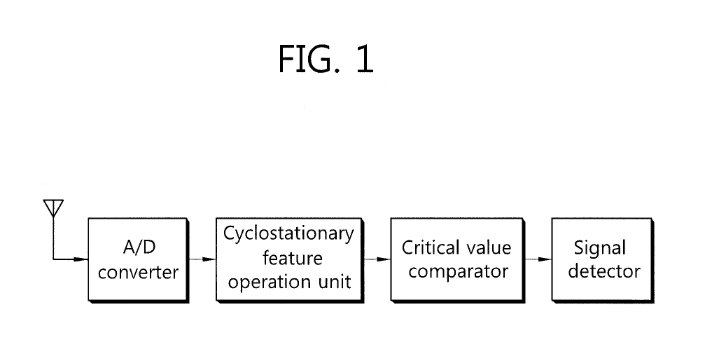

FIG. 1 shows an example of a signal detecting process based on spectral correlation using the spectral correlation function in a cognitive radio (CR) system.

The cyclostationary detecting method converts a received analog signal into a digital signal, obtains a signal correlation using the cyclic autocorrelation function, the spectral correlation function or the like, and determines that the signal of other user (first user and/or other unlicensed user) occupies a spectrum if the obtained correlation is equal to or higher than an average critical value. Since a spectrum resolution becomes fine as the number N of samples increases in a fast Fourier transform (FFT) terminal and thus a frequency resolution is improved, it is possible to recognize a signal having a relatively low signal-to-noise ratio (SNR) or a signal having a narrow band.

Also, since it is possible to lower a noise power level through offsetting of a noise component by prolonging an average time T when calculating the cyclostationary feature, there is an advantage that the SNR is improved in a corresponding channel. However, in the actual use of the CR system, it is impossible to prolong a time T for obtaining the correlation function without any limitation because the unlicensed user has to leave the spectrum empty within a predetermined period of time if the first user appears to use the spectrum while the CR system uses an unoccupied frequency band.

In light of the spectral correlation function, phase and frequency information corresponding to parameters related to time for the modulated signal of the first user are preserved as they are. Further, in accordance with modulation methods, for example, in the case of binary phase shift keying (BPSK) and quadrature phase shift keying (QPSK), they have the same power spectral density (PSD), but their respective spectral correlation functions are surely different, so that a unique intrinsic spectral correlation function providing high autocorrelation on a spectrum can be shown. On the other hand, a noise component and an interference signal do not have the cyclostationary feature, so that a very low correlation value can be shown.

In result, on the basis of information lastly output through signal recognition using the spectral correlation, it is possible to grasp the features such as the number of other users, a signal modulation method of other user system, a symbol transmission rate of other user system, presence of an interference signal in other user channel, etc.

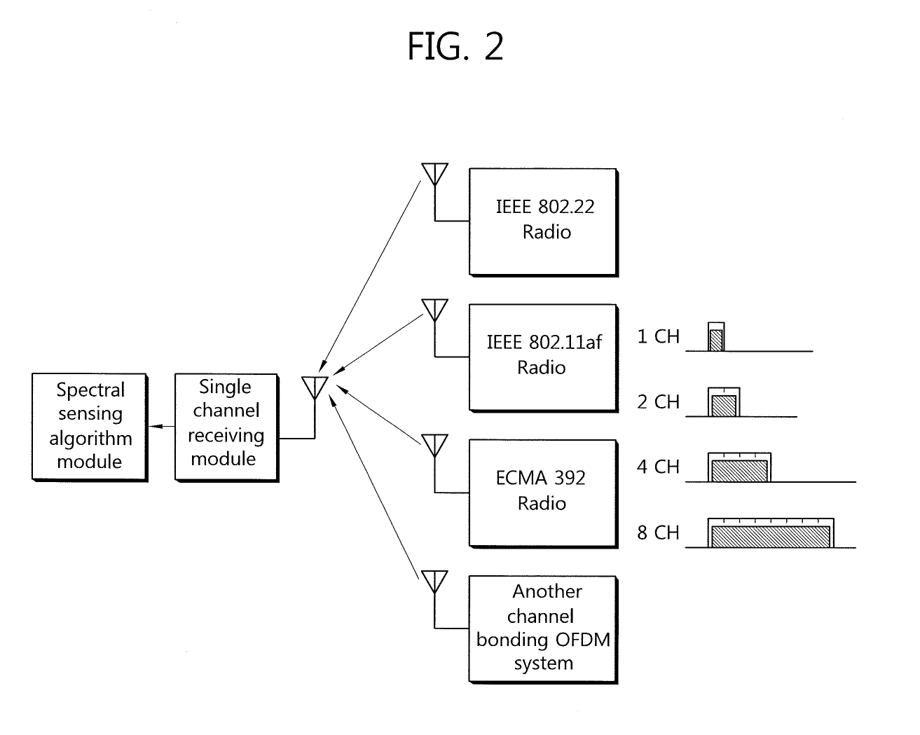

FIG. 2 schematically illustrates an environment of the CR system to which the present invention can be applied.

An IEEE 802.11af system and an ECMA 392 system of FIG. 2 are an example of a system that supports the channel bonding for extending an OFDM signal from one channel to two or more channels, and the present invention is not limited thereto. In other words, an embodiment of the present embodiment can be applied to any OFDM system supporting the channel bonding without being limited by its specific communication protocol, a wireless frame structure, etc.

In a method for detecting an OFDM signal according to an exemplary embodiment of the present invention, it is possible to grasp the kind of received signal and whether channels are bonded, using a spectral sensing algorithm when the OFDM system supporting the channel bonding receives a signal through a single channel receiving module as shown in FIG. 24.

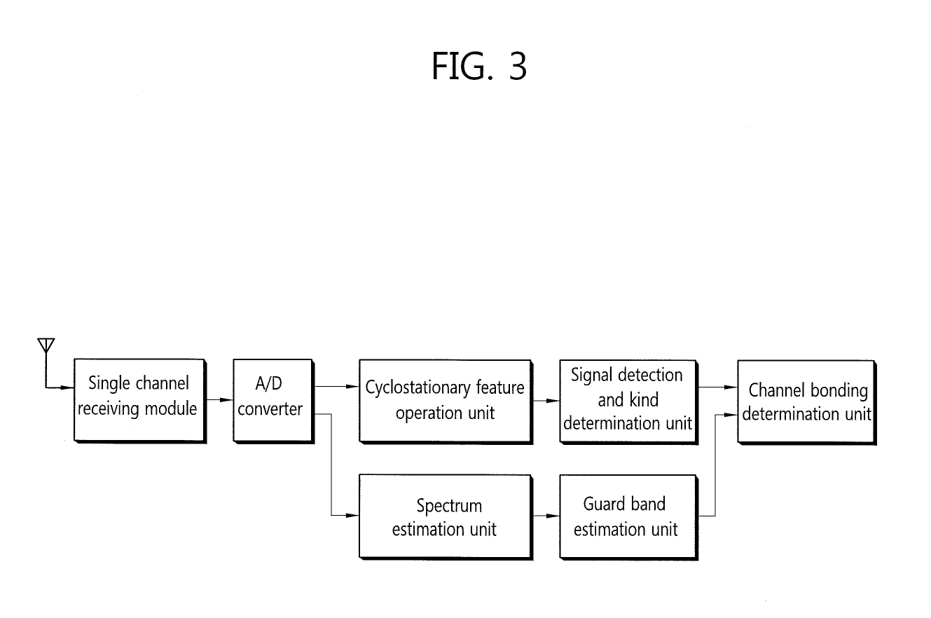

Below, detailed descriptions of the present invention referring to FIG. 3 are as follows.

FIG. 3 illustrates blocks of stages for detecting an OFDM in a wireless apparatus in which the present invention can be embodied.

The wireless apparatus in which the present invention can be embodied includes a single channel sensing receiving radio frequency (RF) unit, an analog/digital (A/D) converter, a cyclostationary feature operation unit, a signal detection and kind determination unit, and a channel bonding determination unit. In addition, the wireless apparatus may further include a spectrum estimation unit and a guard band estimation unit.

The present invention does not employ the additional information transmitted for notifying whether the channels are bonded so that the single channel system such as an IEEE 802.11a system can grasp whether the channels are bonded, but employs the algorithm to grasp the detection of a signal, the kind of signal and whether the channels are bonded, with respect to data obtained from a single channel receiver without the additional information for notifying whether the channels are bonded.

The wireless apparatus, in which an exemplary embodiment of the present invention is realized, receives an OFDM signal through the single channel sensing receiving RF unit.

The received OFDM signal is converted into a digital signal via the A/D converter. The cyclostationary feature operation unit calculates a feature value for detecting the signal and determining the kind of signal on the basis of the cyclic autocorrelation function (CAF), a spectral correlation function (SCF) or the like of the OFDM signal.

The signal detection and kind determination unit determines the presence of the signal and the kind of signal on the basis of the calculated feature value. For example, the cyclostationary feature calculated by the CAF is shown as a cycle of one OFDM symbol including the CP, so that it can be varied depending on a sampling frequency Fs, an FFT size and a CP ratio. If various CR systems are different in the Fs, the FFT size and the CP ratio, they also show different cyclostationary features, respectively. Accordingly, the cyclostationary features can be used in distinguishing the signals.

The channel bonding method for transmitting the OFDM signal through a plurality of channels is classified into a method of maintaining a subcarrier interval by increasing the FFT size in accordance with the number of channels and a method of varying the subcarrier interval by fixing the FFT size regardless the number of bonded channels.

First, an exemplary embodiment of the present invention will be described on the assumption that the same FFT size is constantly kept irrespective of the number of bonded channels. For example, there is a signal of the IEEE 802.11af system. If an OFDM signal of the IEEE 802.11af system has an FFT size of 64, a CP ratio of 1/4, Fs=5 MHz and a single channel receiver has a sampling frequency fs=48/7 MHz, the length of one OFDM symbol including the CP can be calculated as shown in the following equation 1.

$${N}_{s} = 109.7143 ⇐ \frac{64 ( 1 + GIrate )}{5 MHz} = \frac{64 ( 1 + \frac{1}{4} )}{5 MHz} = \frac{{N}_{s}}{\frac{48}{7} MHz} \qquad [ Equation 1 ]$$

In the IEEE 802.11af system, one OFDM symbol shows periodicity according to a repetitive feature of the CP (also differently called GI). Thus, the first cyclic frequency can be calculated as shown in equation 2. Then, the next cyclic frequency appears at integer times of α₁.

$${α}_{1} = 62.500 KHz ⇐ \frac{{F}_{s}}{{N}_{s}} = \frac{5 MHz}{80} = \frac{\frac{48}{7} MHz}{109.7142} \qquad [ Equationxpression 2 ]$$

If two channels are bonded with regard to this signal, the FFT size is constant without variation, but Fs increases up to 10 MHz. In the case that a sensing module is one-channel receiving module, if the A/D converter has a sampling frequency of 48/7 MHz, the size of one OFDM symbol including the CP is as shown in equation 3.

$${N}_{s} = 54.8571 ⇐ \frac{64 ( 1 + {GI}_{rate} )}{10 MHz} = \frac{64 ( 1 + \frac{1}{4} )}{10 MHz} = \frac{{N}_{s}}{\frac{48}{7} MHz} \qquad [ Equation 3 ]$$

Although the channel is increased twice from one channel to two channels, the FFT size is not changed. Thus, it will be appreciated that the number of samples of the sampled OFDM symbol is decreased into half as compared with that calculated in one channel. In accordance with the repetitive features of the CP, the periodicity appears per OFDM symbol, so that the first cyclic frequency can be calculated as shown in equation 4 and show the cyclostationary feature at integer times.

$${α}_{1} = 125 KHz ⇐ \frac{{F}_{s}}{{N}_{s}} = \frac{10 MHz}{64} = \frac{\frac{48}{7} MHz}{54.8571} \qquad [ Equation 4 ]$$

In result, it will be understood that the cyclic frequency increases in proportion as the number of bonded channels increases if the FFT size is constant regardless of the number of bonded channels like IEEE 802.11af. Accordingly, it is possible to determine the detection of the signal, the kind of signal and the number of bonded channels on the basis of the cyclostationary features of the signal received by the single channel sensing receiver.

As opposed to the foregoing example, a case that the single channel receiver receives data as a signal of which the FFT size is increased in proportion to the number of bonded channels will be described. On the assumption that the foregoing example where the FFT size are fixed irrespective of the number of bonded channels is the same as this example except the FFT size, a case that two channels are bonded will be described.

Since two channels have a bandwidth of 10 MHz and an FFT size of 128, the size of one OFDM symbol including the CP can be calculated as shown in equation 5.

$${N}_{s} = 109.7143 ⇐ \frac{128 ( 1 + {GI}_{rate} )}{10 MHz} = \frac{128 ( 1 + \frac{1}{4} )}{10 MHz} = \frac{{N}_{s}}{\frac{48}{7} MHz} \qquad [ Equation 5 ]$$

Referring to the equation, even if the channel bandwidth is increased twice, the FFT size increases in proportion to the channel bandwidth, and therefore there is no variation in a symbol cycle. Thus, the cyclic frequency calculated from this also has the same value. In result, it means that an IEEE 802.11 af signal has the cyclostationary feature always at α=62.5 KHz if it is sampled by the sensing module's A/D conversion sampling frequency of 48/MHz irrespective of the number of bonded channels. In this case, it is possible to distinguish the kind of signal, but it is impossible to determine whether the channels are bonded.

Accordingly, this case has to use the above method together with another method for determining whether the channels are bonded. However, a bandwidth of a guard band, in which a null signal is carried, is varied depending on a spectral characteristic of a channel bonding signal. To grasp this information, a spectrum estimation block may be added.

As described above, if the OFDM signal has a constant FFT size regardless of the number of bonded channels, it is possible to determine whether the channels are bonded on the basis of the cyclic frequency showing the cyclostationary feature. On the other hand, if the FFT size increases in accordance with the number of bonded channels, only the kind of signal can be grasped without determining whether the channels are bonded.

In this case, whether the channels are bonded can be determined through spectrum estimation. For example, in the case of one-channel signal having a bandwidth of 5 MHz like the IEEE 802.11af signal, data occupies a band of 4 MHz, so that there is a guard band of 0.5 MHz at each of opposite sides. However, in the case where two channels are bonded, data occupies a band of 8 MHz in a bandwidth of 10 MHz, so that there is a guard band of 1 MHz at each of opposite sides. Accordingly, it is possible to determine how many channels are bonded on the basis of the bandwidth of the guard band through the spectrum estimation. In the above example, if the guard band has a bandwidth of 0.5 MHz, it is one channel. If the guard band has a bandwidth of 1 MHz, it is determined that two channels are bonded. If the guard band has a bandwidth of 2 MHz, it is determined that four channels are bonded.

The signal detection and kind determination unit calculates a feature value for detecting a signal on the basis of the cyclostationary feature, and determines the presence of the signal and the kind of signal on the basis of the feature value. If the FFT size is constant, it is possible to grasp even the number of bonded channels on the basis of the cyclostationary feature. On the other hand, if the FFT size is varied depending on the number of bonded channels and the kind of signal is determined, the bandwidth of the guard band is varied depending on the kind of signal and the number of bonded channels, so that the channel bonding determination unit can determine the number of bonded channels by comparing the result of channel estimation and the known spectrum.

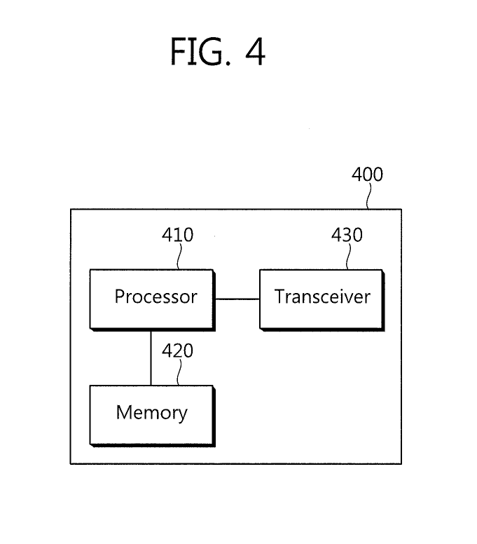

FIG. 4 is a block diagram illustrating the wireless apparatus in which an exemplary embodiment of the present invention is embodied.

The wireless apparatus 400 includes a processor 410, a memory 420 and a transceiver 430. The transceiver 430 transmits/receives an OFDM signal, and senses a signal in a channel. The processor 410 is functionally connected to the transceiver 430 and set up to determine the detection of the signal, the kind of signal and whether the channels are bonded with regard to the OFDM signal received through the transceiver 430 by the processes described with reference to FIG. 3. The wireless apparatus 400 may be achieved by a station of IEEE 802.11af or a CR communication device supporting the ECMA 392 standards in accordance with a wireless communication protocol and the setup embodied in the processor 410.

The processor 410 and/or the transceiver 430 may include an application-specific integrated circuit (ASIC), other chipsets, a logic circuit, and/or a data processor. The memory 420 may includes a read-only memory (ROM), a random access memory (RAM), a flash memory, a memory card, a storage medium and/or other storage devices. If the foregoing embodiments are realized by software, the foregoing method may be achieved by a module (process, function, etc.) implementing the foregoing function. The module may be stored in the memory 420 and executed by the processor 410. The memory 420 may be provided inside or outside the processor 410, and connected to the processor 410 by well-known various means.

As described above, the method for detecting a channel bonding OFDM signal according to an exemplary embodiment of the present invention can determine the detection of the signal, the kind of signal and the bonding information about the channels. Contrary to a conventional IEEE 802.11a OFDM system, a data transceiving module according to the present invention can grasp the detection of the signal and the channel bonding information without additional information transmitted for determining whether the channels are bonded. Accordingly, the data transmission rate can be improved because there is no need for transmitting the additional information, and the communication module's initial access to a network can be quickly performed since the channel bonding information is obtained from the sensing module.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method for detecting an orthogonal frequency division multiplexing (OFDM) signal using a single channel receiver, the method comprising:
receiving sensing data through a single channel receiving radio frequency chain;
obtaining a cyclostationary feature of the sensing data; and
determining presence of a signal on the basis of the cyclostationary feature of the sensing data.

2. The method of claim 1, wherein the determining the presence of the signal comprises comparing the cyclostationary feature of the sensing data with a cyclostationary feature of a known OFDM signal obtained from parameters of the known OFDM signal.

3. The method of claim 1, wherein if the signal exists as a result of determining the presence of the signal, the kind of signal is determined by comparing the cyclostationary feature of the sensing data with a cyclostationary feature of a known OFDM signal.

4. The method of claim 1, wherein if the signal exists as a result of determining the presence of the signal, the number of bonded channels of the signal is determined by comparing the cyclostationary feature of the sensing data with a cyclostationary feature of a known OFDM signal.

5. The method of claim 1, further comprising
estimating a spectrum based on the sensing data; and
determining whether channels receiving the signal are bonded on the basis of the estimated spectrum.

6. The method of claim 5, wherein the determining whether the channels receiving the signal are bonded on the basis of the estimated spectrum comprises comparing a feature of a guard band shown in the estimated spectrum with a guard band of a known OFDM signal.

7. A wireless apparatus for detecting an orthogonal frequency division multiplexing (OFDM) signal using a single channel receiver, the wireless apparatus comprising:
a single channel sensing receiving radio frequency (RF) unit which receives a wireless signal and senses an interest frequency band;
an analog/digital (A/D) converter which converts the wireless signal into a digital signal;
a cyclostationary feature operation unit which obtains a cyclostationary feature of the digital signal;
a signal detection and kind determination unit which determines the kind of wireless signal on the basis of the cyclostationary feature of the digital signal; and
a channel bonding determination unit which determines whether channels are bonded on the basis of the kind of wireless signal determined in the signal detection and kind determination unit.

8. The wireless apparatus of claim 7, further comprising
a spectrum estimation unit which estimates a spectrum based on the digital signal; and
a guard band estimation unit which estimates a bandwidth of a guard band on the basis of the estimated spectrum.

9. A wireless apparatus comprising:
a transceiver which receives a wireless signal; and
a processor which functionally connects with the transceiver and performs signal detection,
the transceiver receiving sensing data through a signal channel receiving radio frequency (RF) chain,
the processor obtaining a cyclostationary feature of the sensing data, and
the cyclostationary feature of the sensing data being used for determining presence of a signal.

10. The wireless apparatus of claim 9, wherein the processor determines the presence of the signal by comparing the cyclostationary feature of the sensing data with a cyclostationary feature of a known OFDM signal obtained from parameters of the known OFDM signal.

11. The wireless apparatus of claim 9, wherein if the signal exists with a result that the processor determines the presence of the signal, the kind of signal is determined by comparing the cyclostationary feature of the sensing data with a cyclostationary feature of a known OFDM signal.

12. The wireless apparatus of claim 9, wherein if the signal exists with a result that the processor determines the presence of the signal, whether channels of the signal are bonded is determined by comparing the cyclostationary feature of the sensing data with a cyclostationary feature of a known OFDM signal.

13. The wireless apparatus of claim 9, wherein the processor estimates a spectrum based on the sensing data, and determines whether channels receiving the signal are bonded on the basis of the estimated spectrum.

14. The wireless apparatus of claim 13, wherein the processor determines whether the channels receiving the signal are bonded on the basis of the estimated spectrum by comparing a feature of a guard band periodically shown in the estimated spectrum with a guard band of a known OFDM signal.
